(19) United States
(12) Patent Application Publication
(10) Pub. No.: US 2007/0264377 A1
(43) Pub. Date: Nov. 15, 2007

(54) In-mold labeling apparatus and method

(75) Inventor: Kirk W. Rudolph, Perrysburg, OH (US)

Correspondence Address: MILES & STOCKBRIDGE PC, 1751 PINNACLE DRIVE, SUITE 500, MCLEAN, VA, 22102-3833, US

(73) Assignee: Graham Packaging Company L.P., York, PA (US)

(21) Appl. No.: 11/826,966

(22) Filed: Jul. 19, 2007

Related U.S. Application Data
(63) Continuation of application No. 10/874,839, filed on Jun. 23, 2004, now abandoned.

(51) Int. Cl. B29C 49/24

(52) U.S. Cl. 425/126.1; 264/112

(57) ABSTRACT

An in-mold labeling apparatus and method has a label magazine for dispensing a plurality of labels in sequence on an endless belt transfer conveyor. A first transfer head removes the labels from the magazine in sequence and places the labels on the conveyor. A drive member indexes the conveyor to space the labels on the conveyor in a direction parallel to the cavity spacing by an amount corresponding to the spacing between the cavities. A carriage is disposed for movement from a first position adjacent the transfer conveyor to a second position adjacent the cavities of the split blow mold. The carriage has at least two second transfer heads operable in the first position of the carriage to pick up labels from the transfer conveyor and operable in the second position to deposit the labels into the mold cavities.

### FIELD OF THE INVENTION

This invention relates generally to blow molding plastic articles and, more particularly to a method and apparatus for providing labels into cavities of a blow mold.

### BACKGROUND OF THE INVENTION

Commonly, labels are applied to an outside surface of blow molded containers to identify and market the contents therein. It is known that labels are applied to the containers as the containers are being formed within a blow mold. A blow mold typically has two or more mold cavities therein so that a plurality of containers are formed during a single blow mold operation. Having multiple mold cavities within a blow mold can make more difficult the endeavor of placing labels within the separate cavities, particularly when more than one label is used per cavity.

It is known to use an endless vacuum transfer conveyor adjacent the mold cavities to facilitate spacing the, labels in an array which corresponds in spacing to the spacing of the separate mold cavities. To transfer the labels from the endless belt conveyor, it is known to use a delivery device that moves downwardly through a top surface of the mold cavity to transfer the labels to the separate mold cavities. With the delivery device entering the mold cavity through the top surface, the delivery device is constructed as a component on an extruder which also enters the separate mold cavities through the top surface, wherein the delivery device and the extruder move conjointly with one another. As such, the delivery device must coordinate its cycle time with the extruder.

### SUMMARY OF THE INVENTION

A method and apparatus for placing labels into at least two cavities of a blow mold. The apparatus has a label magazine for dispensing a plurality of labels in sequence on an endless belt transfer conveyor positioned adjacent thereto. A first transfer head is positioned adjacent to the magazine and the conveyor for removing labels from the magazine in sequence and placing the labels on the conveyor. A drive member communicates with the conveyor to index the conveyor in a direction parallel to the direction of the cavity spacing, such that the labels on the conveyor are spaced from each other in a direction parallel to the cavity spacing by an amount corresponding to the spacing between the separate cavities. A carriage is disposed for movement from a first position adjacent the transfer conveyor to a second position adjacent the cavities of the split blow mold. The carriage has at least two second transfer heads operable in the first position of the carriage to pick up labels from the transfer conveyor and operable in the second position to deposit the labels into the mold cavities.

### BRIEF DESCRIPTION OF THE DRAWINGS

These and other objects, features, advantages and aspects of the present invention will be apparent from the following detailed description of the preferred embodiments and best mode, appended claims and accompanying drawings in which:

FIG. 1 is a schematic plan view of an in-mold labeling apparatus constructed according to one embodiment of the invention having a carriage shown in a first position;

FIG. 2 is an elevation view of FIG. 1;

FIG. 3 is a view similar to FIG. 1 with the carriage shown in a second position;

FIG. 4 is an elevation view of FIG. 3; and

FIG. 5 is a plan view of a transfer head of the apparatus of FIG. 1 shown transferring labels from a label magazine to a continuous belt conveyor.

### DETAILED DESCRIPTION OF THE PREFERRED EMBODIMENTS

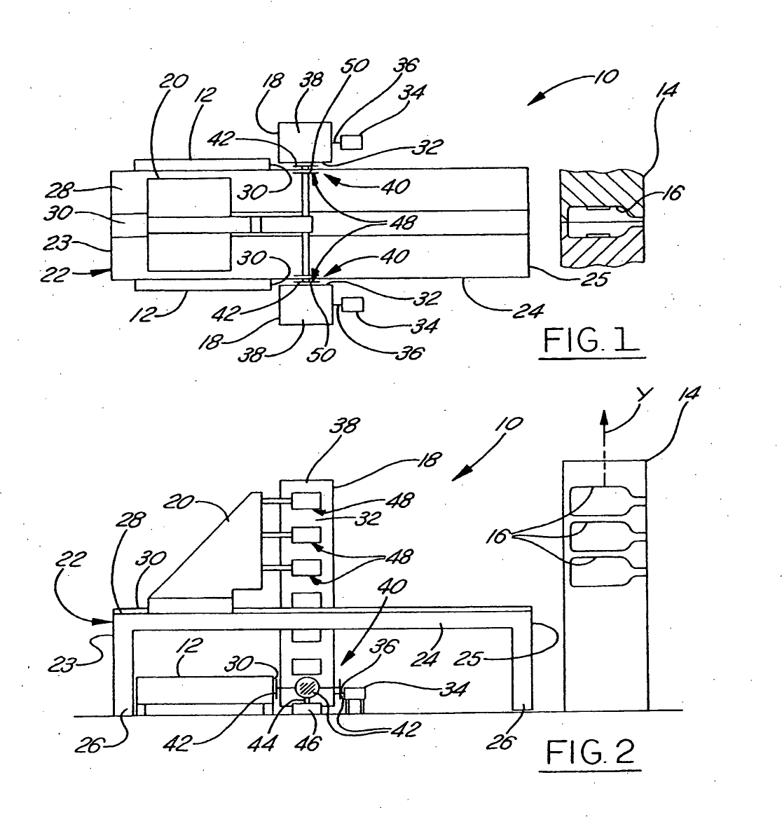

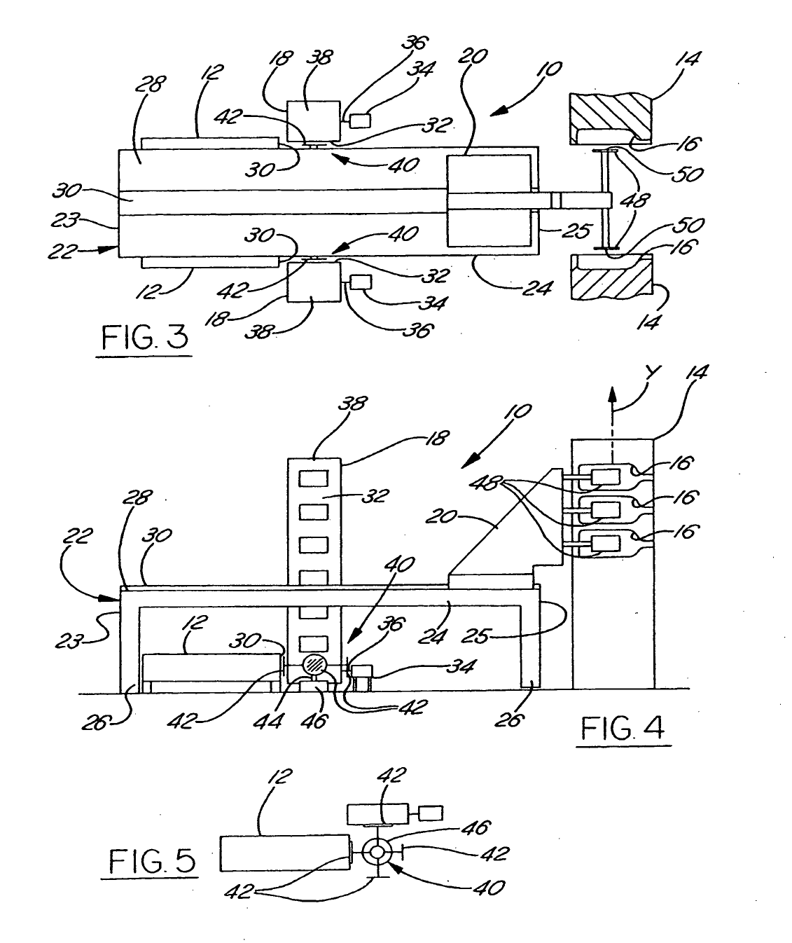

Referring in more detail to the drawings, FIGS. 1-4 illustrate an in-mold labeling apparatus 10 constructed according to one embodiment of the invention. The apparatus 10 transfers labels from at least one, and shown here as a pair of label magazines 12 into a mold 14 having at least two cavities, and shown here as three cavities 16 (FIGS. 2 and 4) spaced from each other in a first direction (Y). The labels are removed individually from the label magazines 12 and placed on a pair of transfer conveyors 18. The transfer conveyors 18 move the labels in an individually spaced relation, corresponding to the spacing between the cavities 16, to a carriage 20. The carriage 20 carries the labels from a first position (FIGS. 1 and 2) adjacent the transfer conveyor 18 to a second position (FIGS. 3 and 4) adjacent the cavities 16 of the spilt mold 14. When in its second position, the carriage 20 places the labels in their respective cavities 16 of the split mold 14. Upon placing the labels in the cavities 16, the carriage 20 returns to its first position to repeat the process for a subsequent blow molding cycle.

The apparatus 10 has a carriage support 22 with a platform 24 supported by a pair of legs 26 at opposite ends 23, 25 of the platform 24. The platform 24 has an upper surface 28 with a way 30 preferably extending along the upper surface 28 between the opposite ends 23, 25. The way 30 provides guided support for the carriage 20 between its first and second positions and may incorporate linear bearings (not shown) to facilitate reducing the friction between the upper surface 28 and the carriage 20 during movement of the carriage 20 between its first and second positions.

The label magazines 12 are disposed adjacent opposite sides of the carriage and preferably are located near one end 23 of the carriage support 22 and have an inner cavity sized to receive the plurality of the labels arranged in sequence therein. Desirably, a separate one of the magazines 12 dispenses labels for a separate half of each of the cavities 16. The labels are preferably biased toward a dispensing end 30 of the magazines 12 by plunger or spring member (not shown) within the magazines 12. The dispensing ends 30 of the magazines 12 preferably have inwardly extending fingers (not shown) to facilitate dispensing individual labels in sequence to the transfer conveyors 18.

The transfer conveyors 18 have a vacuum surface 32, such as disclosed in U.S. Pat. No. 4,636,166 to Franks et al. and in U.S. Pat. No. 5,230,502 to Plenzler et al., incorporated herein in their entirety. The transfer conveyors 18 are located on opposite sides of the carriage support 22 and generally adjacent the dispensing ends 30 of the magazines 12 with the vacuum surfaces 32 facing one another. Each transfer conveyor 18 has a drive member 34, such as an electric motor having a drive shaft 36 in operable engagement with the respective transfer conveyor 18 for indexing a belt 38 on each transfer conveyor 18 in a direction parallel to the first direction (Y) of the spacing between the cavities 16. As such, when the labels are placed on the belts 38, they are spaced from each other in a direction parallel to the spacing of the cavities 16 by an amount corresponding to the spacing between the cavities 16 (FIGS. 2 and 4).

To facilitate placing the labels on the transfer conveyors 18, a pair of first transfer heads 40 (FIG. 5) are provided, wherein a separate one of the first transfer heads 40 is positioned adjacent the dispensing end 30 of a separate magazine 12 and the respective transfer conveyor 18. Each of the first transfer heads 40 is shown here having a plurality of vacuum cups 42 supported for rotation about a drive shaft 44 of an actuator 46, such as an electric motor. The vacuum cups 42 are oriented so that when they are rotated adjacent the dispensing end 30 of the respective label magazines 12, they remove a single label from the respective label magazine 12. To facilitate picking up the labels from the magazines 12, the vacuum cups 42 may extend outwardly toward the respective magazine 12, such as through the use of a solenoid actuator (not shown), a cam mechanism (not shown), or a pivotal link arm assembly, for example. As shown here, each first transfer head 40 has four vacuum cups 42, such that the vacuum cups 42 are rotated in 90° increments to pick up the labels from the magazines 12 and to place the individual labels onto the transfer conveyors 18. Desirably, the first transfer heads 40 operate in unison with one another to place the labels on opposite transfer conveyors 18 so that the labels are in generally mirrored relation to one another. It should be recognized that the first transfer heads 40 may have fewer or lesser vacuum cups 42, as desired. It should also be recognized that the vacuum cups 42 may extend outwardly to place the labels on the transfer conveyors 18, as discussed above with regard to picking up the labels from the label magazines 12.

To facilitate transferring the individually spaced labels from the separate transfer conveyors 18 to the carriage 20 while in its first position adjacent the transfer conveyors 18, the carriage 20 has at least two second transfer heads 48, preferably corresponding in number to the number of individual labels being placed at any one time within the cavities 16 of the split mold 14. Accordingly, since the split mold 14, as shown here by way of example, has three cavities 16, and with each cavity 16 having separate halves receiving a label, a total of six second transfer heads 48 are incorporated on the carriage 20. Three of the second transfer heads 48 are arranged to pick up three corresponding labels from one transfer conveyor 18, while the remaining three second transfer heads 48 are arranged to pick up the three labels from the other transfer conveyor 18. The second transfer heads 48 preferably have vacuun cups 50 (FIGS. 1 and 3) to pick up the labels from the respective transfer conveyors 18, such as those described on the first transfer head 40.

Upon the second transfer heads 48 picking up the labels from the respective transfer conveyors 18, the carriage 20 is moved to its second position, such as through the use of hydraulics, ball screw, or the like, so that when the carriage 20 is in its second position, the second transfer heads 48 are operably positioned to deposit the labels into their respective mold cavities 16. To facilitate the transfer of the labels to the mold cavities 16, the second transfer heads 48 may extend outwardly toward their respective cavities 16, such as through the use of a solenoid actuator (not shown), a cam mechanism (not shown), or a pivoted link arm assembly, for example, to place the labels into the respective cavities 16. Upon placing the labels in the mold cavities 16, the carriage 20 returns to its first position to retrieve a new set of labels already positioned on the transfer conveyors 18 in their spaced relation corresponding to the spacing between the cavities 16 in the split mold. This results at least in part from the first transfer heads 40 continuing to place labels on the respective transfer conveyors 18 while the carriage 20 is away from its first position. The second transfer heads 48 may repeat the process of picking up the labels for transfer to the mold cavities 16 independent from the operation of other mechanisms used in the blow molding process, such as an extruder. It should be understood that the movement of the carriage 20 between its first and second position coincides with the blow molding of the containers within the split mold 14, such as through the incorporation of a controller in communication with the driving devices, such as servo motors or hydraulic actuators, for example. As such, as soon as one set of containers are blow molded and removed from the cavities 16, a new set of labels are ready for immediate placement into the vacated cavities 16.

It should be recognized that upon reading the disclosure herein, one ordinarily skilled in the art of in-mold labeling apparatus and blow molding would readily recognize other embodiments than those disclosed herein, with those embodiments being within the scope of any claims that issue at. least in part from this disclosure. Accordingly, this disclosure herein is intended to be exemplary, and not limiting. The scope of the invention is defined by the claims that follow.

1. An apparatus for placing labels into cavities of a mold having at least two cavities spaced from each other in a first direction, said apparatus comprising:
a label magazine for dispensing a plurality of labels in sequence;
an endless belt transfer conveyor positioned adjacent to said magazine;
a first transfer head for removing labels from said magazine in sequence and placing the labels on said transfer conveyor;
a drive member for indexing said transfer conveyor in a direction parallel to said first direction such that labels on said transfer conveyor are spaced from each other in a direction parallel to said first direction and by an amount corresponding to spacing between the cavities in the mold;
a carriage disposed for movement in a second direction from a first position adjacent to said transfer conveyor to a second position adjacent to the cavities of the split mold, and
at least two second transfer heads on said carriage, said second transfer heads being operable in said first position of said carriage to pick up labels from said transfer conveyor and being operable in said second position of said carriage to deposit the labels into the mold cavities.

2. The apparatus of claim 1 wherein said second direction is perpendicular to said first direction.

3. The apparatus of claim 1 wherein said first transfer head continues placing the labels on said transfer conveyor when said carriage is away from said first position.

4. The apparatus of claim 3 wherein said first transfer head and said transfer conveyor operate at a speed so that the labels are arranged on said transfer conveyor prior to said carriage returning to said first position from said second position.

5. The apparatus of claim 1 including a pair of said label magazines with a separate one of said label magazines dispensing labels for a separate half of each of the cavities.

6. The apparatus of claim 5 including a pair of transfer conveyors with a separate one of said transfer conveyors receiving labels from a separate one of said label magazines.

7. The apparatus of claim 6 including a pair of first transfer heads with a separate one of said transfer heads cooperating with a separate one of said magazines and a separate one of said transfer conveyors.

8. The apparatus of claim 6 wherein said first transfer heads and said transfer conveyors operate in unison to dispense the labels on said transfer conveyors in generally mirrored relation to one another.

9. A method of placing labels into cavities of a mold having at least two cavities spaced from each other in a first direction, comprising the steps of:
providing a label magazine;
loading the label magazine with a plurality of labels;
providing an endless belt transfer conveyor adjacent to said label magazine;
providing a first transfer head adjacent said magazine and said transfer conveyor;
actuating said first transfer head and removing the labels from said magazine in sequence;
indexing said transfer conveyor in a direction parallel to said first direction;
transferring the labels from said first transfer head to said transfer conveyor in spaced relation from each other in a direction parallel to said first direction and by an amount corresponding to spacing between the separate cavities;
providing a carriage disposed for movement in a second direction from a first position adjacent to said transfer conveyor to a second position adjacent to the cavities, and
providing at least two second transfer heads on said carriage spaced from one another for engagement with the labels on said transfer conveyor;
actuating said second transfer heads while said carriage is in said first position and picking up the labels from said transfer conveyor;
moving said carriage from its first position to its second position; and
actuating said second transfer heads while said carriage is in said second position and placing the labels into the mold cavities.

10. The method of claim 9 wherein said second direction is substantially perpendicular to said first direction.

11. A method of placing labels into cavities of a mold having at least two cavities spaced from each other in a first direction, comprising the steps of:
providing a supply of labels, a transfer conveyor and a carriage;
placing individual labels on said transfer conveyor;
moving the transfer conveyor in said first direction so that said labels are spaced apart a distance equal to the distance between said cavities;
transferring said spaced labels to said carriage;
moving said carriage in a second direction from a position adjacent the transfer conveyor to a position adjacent the cavities; and
transferring said labels from said carriage to said cavities.

12. The method of claim 11 wherein said second direction is substantially perpendicular to said first direction.
